(19) United States
(12) Patent Application Publication
(10) Pub. No.: US 2015/0240883 A1
(43) Pub. Date: Aug. 27, 2015

(54) CLUTCH ASSEMBLY HAVING A CLAMP SPRING

(71) Applicant: Schaeffler Technologies AG & Co. KG, Herzogenaurach (DE)

(72) Inventors: Miguel Huerta Pérez, Puebla (MX); Sonia Betsabé Macías Espinosa, Puebla (MX); Geraldy Santiago Rosas, Puebla (MX)

(21) Appl. No.: 14/619,802

(22) Filed: Feb. 11, 2015

Related U.S. Application Data
(60) Provisional application No. 61/943,083, filed on Feb. 21, 2014.

(51) Int. Cl. F16D 13/75; F16D 13/42

(52) U.S. Cl. CPC F16D 13/757; F16D 13/42

(57) ABSTRACT

A clutch assembly for transferring torque between a flywheel of an engine and a transmission, the clutch assembly comprising a housing, a pressure plate fixedly secured to the housing, the pressure plate operatively arranged to cause a friction clutch disc to rotate the flywheel, wherein the pressure plate is arranged for rotation about an axis of rotation, wherein the pressure plate is axially movable relative to the axis of rotation, and including actuation means for engaging and disengaging the clutch, an adjustment means operatively arranged to adjust travel of the pressure plate and the friction clutch disc, and a plurality of lever arms, operatively arranged to amplify force within the clutch assembly, the adjustment means comprising a clamp spring having a first end operatively arranged to prevent an uncontrolled movement of the adjustment means and a second end operatively arranged to center the adjustment means within the clutch assembly.

### CROSS-REFERENCE TO RELATED APPLICATIONS

This application claims the benefit under 35 U.S.C. §119(e) of U.S. Provisional Patent Application No. 61/943,083, filed Feb. 21, 2014, which application is incorporated herein by reference in its entirety.

### FIELD OF THE INVENTION

The invention relates to a clutch assembly and, more specifically, to a clamp spring of a clutch assembly.

### BACKGROUND

Clutch assemblies are used in some forms of drivetrains of motor vehicles between an engine and a transmission. A motor vehicle typically includes a single clutch or a dual clutch. In a motor vehicle with a single clutch, the clutch is coupled between the crankshaft and the input shaft of the transmission, thereby transferring torque from the crankshaft to the transmission. In a motor vehicle with a dual clutch, torque is transferred to two transmission input shafts coaxially in relation to one another. Over time, the friction disc in the clutch assembly becomes increasingly worn. In order to compensate for the wear of the friction disc, some clutch assemblies include a means for adjusting the clutch assembly in relation to the amount of wear endured by the friction disc. However, prior to the installation of a clutch assembly in an automobile, an uncontrolled movement of the adjustment means can occur. In order to prevent this uncontrolled movement of the adjustment means (which includes the adjuster ring and sensor ring), a transport lock has been used.

FIG. 2 is a top plan view of transport lock 200 of typical clutch assembly 100 (shown in FIG. 3). In FIG. 2, transport lock 200 is formed as a ring which is fixedly secured to housing 130 (shown in FIG. 3) of clutch assembly 100 (shown in FIG. 3). Transport lock 200 includes first set of teeth 201, second set of teeth 202, and third set of teeth 203. First set of teeth 201 is fixedly connected to second set of teeth 202 by bar 204. Second set of teeth 202 is fixedly connected to third set of teeth 203 by bar 205. Third set of teeth 203 is fixedly connected to first set of teeth 201 by bar 206. First set of teeth 201 includes four teeth members 208, 209, 210 and 211. Second set of teeth 202 includes four teeth members 212, 213, 214 and 215. Third set of teeth 203 includes four teeth members 216, 218, 219 and 220. Teeth members 208, 211, 212, 215, 216 and 220 further include notches 208n, 211n, 212n, 215n, 216n and 220n, respectively.

FIG. 3 is a fragmentary top view of the adjustment means of typical clutch assembly 100 having at least one clutch, of which the adjustment means compensates for the wear of at least one friction disc. In order to compensate for the wear of the friction disc, clutch assembly 100 comprises a preloaded adjuster ring 140 (shown in FIG. 4) and a preloaded sensor ring 150 (shown in FIG. 4) with ramps being provided between the clutch housing 130 and the lever plate 101. The adjuster ring and the sensor ring are preloaded in a circumferential direction with pressure springs such that when the friction disc becomes increasingly worn, adjuster ring 140 (shown in FIG. 4) and sensor ring 150 (shown in FIG. 4) move in order to compensate the gap created between the pressure plate and the friction disc. The activation of the adjustment process is determined by sensor devices which measure a travel or actuating force of plurality of lever arms 102, 103, 104, 105, 106, and 108. The sensor devices comprise clamp spring 300 and adjustment tab 160 (shown in FIG. 6). Clamp spring 300, which is arranged to engage adjustment tab 160 (shown in FIG. 6), is fixedly secured to housing 130 of clutch assembly 100 by rivets 131 and 132, whereby rivets 131 and 132 pass through notches 211n and 212n (shown in FIG. 2) of transport lock 200 (shown in FIG. 2) and washers 221 and 222 (not shown), respectively.

To prevent an uncontrolled movement of adjuster ring 140 (shown in FIG. 4) prior to the installation of clutch assembly 100 in an automobile, transport lock 200 (shown in FIG. 2) prevents a complete relaxation of lever arms 102, 103, 104, 105, 106 and 108. Transport lock 200 (shown in FIG. 2) is positioned between clamp spring 300 and lever plate 101, which is fixedly connected to lever arms 102, 103, 106, and 108. Lever arms 102, 103, 104, 105, 106 and 108 further include apertures 102a, 103a, 104a, 105a, 106a and 108a, respectively, which allow teeth 210, 211, 212 and 213 of transport lock 200 (shown in FIG. 2) to protrude perpendicularly to the plane of axis of lever arms 102, 103, 106, 108, through apertures 102a, 103a, 106a and 108a, respectively. Bar 204 of transport lock 200 (shown in FIG. 2) is arranged to engage lever arms 104 and 105. Washers 221 and 222 (not shown) are positioned between transport lock 200 (shown in FIG. 2) and clamp spring 300, and washers 221 and 222 (not shown) are positioned over notches 211n and 212n (shown in FIG. 2) of transport lock 200 (shown in FIG. 2), respectively, to create a gap between transport lock 200 (shown in FIG. 2) and clamp spring 300. It should be appreciated that washers 221 and 222 (not shown) are used to ensure the proper function of transport lock 200 (shown in FIG. 2).

FIG. 4 is a fragmentary cross sectional view of the adjustment means of typical clutch assembly 100, taken generally along line 4-4 in FIG. 3. In FIG. 4, transport lock 200 (shown in FIG. 2) places a predetermined load on lever arms 102, 103, 104, 105, 106, and 108 (shown in FIG. 3) which prevents a complete relaxation of lever arms 102, 103, 104, 105, 106, and 108 (shown in FIG. 3). Lever arms 102, 103, 104, 105, 106, and 108 (shown in FIG. 3) are oriented radially and fixedly connected to lever plate 101. As transport lock 200 (shown in FIG. 2) applies a predetermined load onto lever arms 102, 103, 104, 105, 106, and 108 (shown in FIG. 3), lever plate 101 in turn applies a load to adjuster ring 140, thereby preventing an uncontrolled movement of adjuster ring 140. Once clutch assembly 100 is connected to the transmission of an automobile, a load is placed on lever arms 102, 103, 104, 105, 106 and 108 (shown in FIG. 3) greater than the load applied by transport lock 200 (shown in FIG. 2), such that lever arms 102, 103, 104, 105, 106, and 108 (shown in FIG. 3) no longer engage transport lock 200 (shown in FIG. 2), thereby allowing the actuation means necessary to engage the pressure plate with the friction disc.

FIG. 5 is a perspective view of typical clamp spring 300 of clutch assembly 100 (shown in FIG. 3). In FIG. 5, clamp spring 300 is formed as a tripartite member fixedly secured to housing 130 (shown in FIG. 3) of clutch assembly 100 (shown in FIG. 3). Clamp spring 300 includes body 301, first end 302, second end 303 and third end 304. First end 302 of body 301 is formed by first flat member 305, second flat member 306 and arcuate member 308, and the first and second flat members 305 and 306 are fixedly connected by arcuate member 308. Second end 303 of body 301 is formed by flat member 309. Third end 304 of body 301 is formed by first flat member 310, second flat member 311 and arcuate member 312, and the first and second flat members 310 and 311 are fixedly connected by arcuate member 312. Body 301, first end 302 and second end 303 further contain apertures 301a, 302a and 303a, respectively.

FIG. 6 is a fragmentary cross sectional view of the adjustment means of typical clutch assembly 100 having clamp spring 300, taken generally along line 4-4 in FIG. 3. In FIG. 6, clamp spring 300 is positioned between transport lock 200 (shown in FIG. 2) and housing 130 of clutch assembly 100. First end 302 of clamp spring 300 includes first flat member 305, second flat member 306 and arcuate member 308, and the first and second flat members 305 and 306 are fixedly connected by arcuate member 308. The adjustment tab 160 is fixedly secured to second flat member 306 of first end 302 of body 301 (shown in FIG. 5) of clamp spring 300 by bolt 133, which passes from adjustment tab 160 through aperture 302a (shown in FIG. 5) of second flat member 306 of first end 302. The adjustment tab 160, which is fixedly secured to clamp spring 300, also engages lever plate 101. Clamp spring 300 and adjustment tab 160 measure the travel or actuating force of lever arms 102, 103, 104, 105, 106, and 108 and prevent an uncontrolled movement of the sensor ring (shown in FIG. 3).

During the lifetime of clutch assembly 100, the distance between the pressure plate and the friction disc should remain constant. However, as the friction disc becomes increasingly worn, the distance between the pressure plate and the friction disc increases, which in turn results in an increase of the travel necessary to engage the pressure plate with the friction disc. The adjustment tab 160, which is fixedly secured to clamp spring 300 and places a predefined load on sensor ring 150, senses the amount of wear or distance between the pressure plate and the friction disc. The adjustment tab 160 is further placed over the lever plate 101, whereby an increase in the travel necessary to engage the pressure plate with the friction disc (larger than the gap between adjustment tab 160 and lever plate 101) produces a higher axial movement of lever plate 101, engaging adjustment tab 160. Since adjustment tab 160 is also fixedly secured to clamp spring 300, the axial movement of lever plate 101 causes adjustment tab 160 and clamp spring 300 to undergo a travel or distance equal to the increase in distance between the pressure plate and the worn friction disc.

To compensate for the increased travel or distance between adjustment tab 160 and sensor ring 150, and thus an increase in the distance necessary for the pressure plate to engage with the friction disc, sensor ring 150 moves axially along the axis of rotation to reengage with adjustment tab 160. As sensor ring 150 reengages with adjustment tab 160, adjuster ring 140 simultaneously moves axially along the axis of rotation a distance equal to the distance traveled by sensor ring 150. As adjuster ring 140 moves axially, adjustment means (comprising adjuster ring 140, sensor ring 150, clamp spring 300, adjustment tab 160 and lever plate 101) is moved axially along the axis of rotation a distance equivalent to that traveled by adjuster ring 140 and sensor ring 150, such that the distance between the pressure plate and the friction disc remains constant.

Clutch assembly 100 (shown in FIG. 3) is installed in an automobile, centering pin 400 (shown in FIG. 7) further prevents an uncontrolled movement of sensor ring 150 (shown in FIG. 6). FIG. 7 is a perspective view of typical centering pin 400 of clutch assembly 100 (shown in FIG. 8). The centering pin 400 engages sensor ring 150 (shown in FIG. 8) of clutch assembly 100 (shown in FIG. 8) to center sensor ring 150 as sensor ring 150 moves axially within clutch assembly 100 (shown in FIG. 8). The centering pin 400 is formed as an “L” shaped bracket, having first flat member 401 and second flat member 402. First flat member 401 of centering pin 400 lies perpendicularly to the plane of axis of second flat member 402 of centering pin 400. First flat member 401 further contains aperture 401a.

FIG. 8 is a fragmentary top view of the adjustment means of typical clutch assembly 100 having centering pin 400. In FIG. 8, clamp spring 300 and centering pin 400 are both independently operable and spatially oriented within clutch assembly 100. With housing 130 (shown in FIG. 3) removed, aperture 401a of centering pin 400 and aperture 303a of clamp spring 300 can be seen. Centering pin 400 and second end 303 of clamp spring 300 are fixedly secured to housing 130 (shown in FIG. 3) by rivets 403 (shown in FIG. 9) and 131 (shown in FIG. 3), respectively, which pass through apertures 401a and 303a, respectively. It should be appreciated that clamp spring 300 and centering pin 400 are two distinct structures. First flat member 401 of centering pin 400 is fixedly secured to housing 130 (shown in FIG. 3) by rivet 403 (shown in FIG. 9). First flat member 401 of centering pin 400 lies parallel to the plane of axis of housing 130 (shown in FIG. 9). Second flat member 402 of centering pin 400 lies perpendicular to the plane of axis of housing 130 (shown in FIG. 9). As clutch assembly 100 rotates about an axis of rotation, second flat member 402 of centering pin 400 is engaged with sensor ring 150 to center sensor ring 150 and thereby prevent sensor ring 150 from moving within a plane perpendicular to the axis of rotation of clutch assembly 100.

FIG. 9 is a fragmentary partial cross sectional view of the adjustment means of typical clutch assembly 100 having centering pin 400, taken generally along line 8-8 in FIG. 8. In FIG. 9, centering pin 400 is fixedly secured to housing 130 of clutch assembly 100 by rivet 403. First flat member 401 of centering pin 400 lies parallel to the plane of axis of housing 130. Second flat member 402 of centering pin 400 lies perpendicularly to the plane of axis of housing 130. As clutch assembly 100 rotates about an axis of rotation, second flat member 402 of centering pin 400 is engaged with sensor ring 150 to center sensor ring 150 and thereby prevents sensor ring 150 from moving within a plane perpendicular to the axis of rotation of clutch assembly 100.

Thus, there has been a long-felt need for a clamp spring for a clutch assembly which prevents an uncontrolled movement of the adjustment means within the clutch assembly.

### SUMMARY

The present invention broadly comprises a clutch assembly for transferring a torque between a flywheel of an engine and a transmission in a motor vehicle, the clutch assembly comprising a housing, a pressure plate fixedly secured to the housing, the pressure plate operatively arranged to cause a friction clutch disc to rotate the flywheel, wherein the pressure plate is arranged for rotation about an axis of rotation, wherein the pressure plate is axially movable relative to the axis of rotation, and including actuation means for engaging and disengaging the clutch, an adjustment means operatively arranged to adjust travel of the pressure plate and the friction clutch disc, and a plurality of lever arms, operatively arranged to amplify force within the clutch assembly, the adjustment means comprising a clamp spring having a first end operatively arranged to prevent an uncontrolled movement of the adjustment means and a second end operatively arranged to center the adjustment means within the clutch assembly.

A general object of the invention is to provide a clamp spring that prevents an unwanted movement of the adjustment means of a clutch assembly.

Another object of the invention is to provide a clamp spring that prevents an unwanted movement of the adjuster ring of a clutch assembly.

Yet another object of the invention is to provide a clamp spring that prevents an unwanted movement of the sensor ring of a clutch assembly.

A further object of the invention is to provide a cost savings for the manufacturing and production of a transport lock for an adjustment device within a clutch assembly.

A further object of the invention is to provide a cost savings for the manufacturing and production of a centering pin for an adjustment device within a clutch assembly.

These and other objects, features and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a top plan view of transport lock 200 of typical clutch assembly 100;

FIG. 3 is a fragmentary top view of the adjustment means of typical clutch assembly 100;

FIG. 4 is a fragmentary cross sectional view of the adjustment means of typical clutch assembly 100 taken generally along line 4-4 in FIG. 3;

FIG. 5 is a perspective view of typical clamp spring 300 of typical clutch assembly 100;

FIG. 6 is a fragmentary cross sectional view of the adjustment means of typical clutch assembly 100 having clamp spring 300 taken generally along line 4-4 in FIG. 3;

FIG. 7 is a perspective view of typical centering pin 400 of typical clutch assembly 100;

FIG. 8 is a fragmentary top view of the adjustment means of typical clutch assembly 100 having centering pin 400;

FIG. 9 is a fragmentary partial cross sectional view of the adjustment means of typical clutch assembly 100 having centering pin 400 taken generally along line 8-8 in FIG. 8;

FIG. 10 is a fragmentary top view of the adjustment means of clutch assembly 500 of the present invention;

FIG. 11A is a perspective view of clamp spring 600 of the present invention, illustrating clamp spring 600 which includes nose 602B and tab 603B;

FIG. 11B is a perspective view of another embodiment of clamp spring 700, illustrating clamp spring 700 which includes nose 702B and tab 703B;

FIG. 11C is a perspective view of another embodiment of clamp spring 800, illustrating clamp spring 800 which includes nose 802B and tab 803B;

FIG. 12 is a fragmentary cross sectional view of the adjustment means of clutch assembly 500 of the present invention, illustrating clamp spring 600 which includes nose 602B taken generally along line 12-12 in FIG. 10;

FIG. 13 is a fragmentary top view of the adjustment means of clutch assembly 500 of the present invention, illustrating clamp spring 600 which includes tab 603B;

FIG. 14 is a fragmentary partial cross sectional view of the adjustment means of clutch assembly 500 of the present invention, illustrating clamp spring 600 which includes tab 603B taken generally along line 14-14 in FIG. 13;

FIG. 15 is a fragmentary top view of the adjustment means of clutch assembly 500 of the present invention, illustrating clamp spring 700 which includes tab 703B;

FIG. 16 is a fragmentary partial cross sectional view of the adjustment means of clutch assembly 500 of the present invention, illustrating clamp spring 700 which includes tab 703B taken generally along line 16-16;

FIG. 17 is a fragmentary top view of the adjustment means of clutch assembly 500 of the present invention, illustrating clamp spring 800 which includes tab 803B; and,

FIG. 18 is a fragmentary partial cross sectional view of the adjustment means of clutch assembly 500 of the present invention, illustrating clamp spring 800 which includes tab 803B taken generally along line 18-18 in FIG. 17.

### DETAILED DESCRIPTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this patent is not limited to the particular methodology, materials and modifications described and as such may, of course, vary. It is also understood that the terminology used herein is for the purpose of describing particular aspects only, and is not intended to limit the scope of the present invention as claimed.

Unless defined otherwise, all technical and scientific terms used herein have the same meaning as commonly understood to one of ordinary skill in the art to which this invention belongs. It should be understood that any methods, devices or materials similar or equivalent to those described herein can be used in the practice or testing of the invention.

By “non-rotatably connected” first and second components we mean that the first component is connected to the second component so that any time the first component rotates, the second component rotates with the first component, and any time the second component rotates, the first component rotates with the second component. Axial displacement between the first and second components is possible.

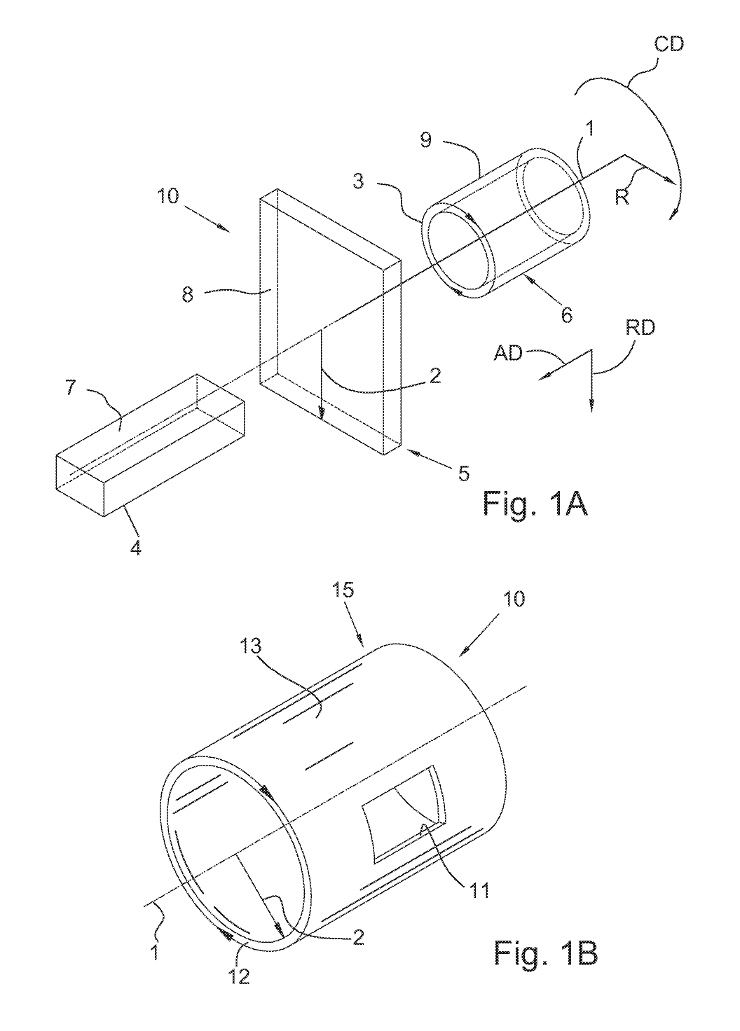

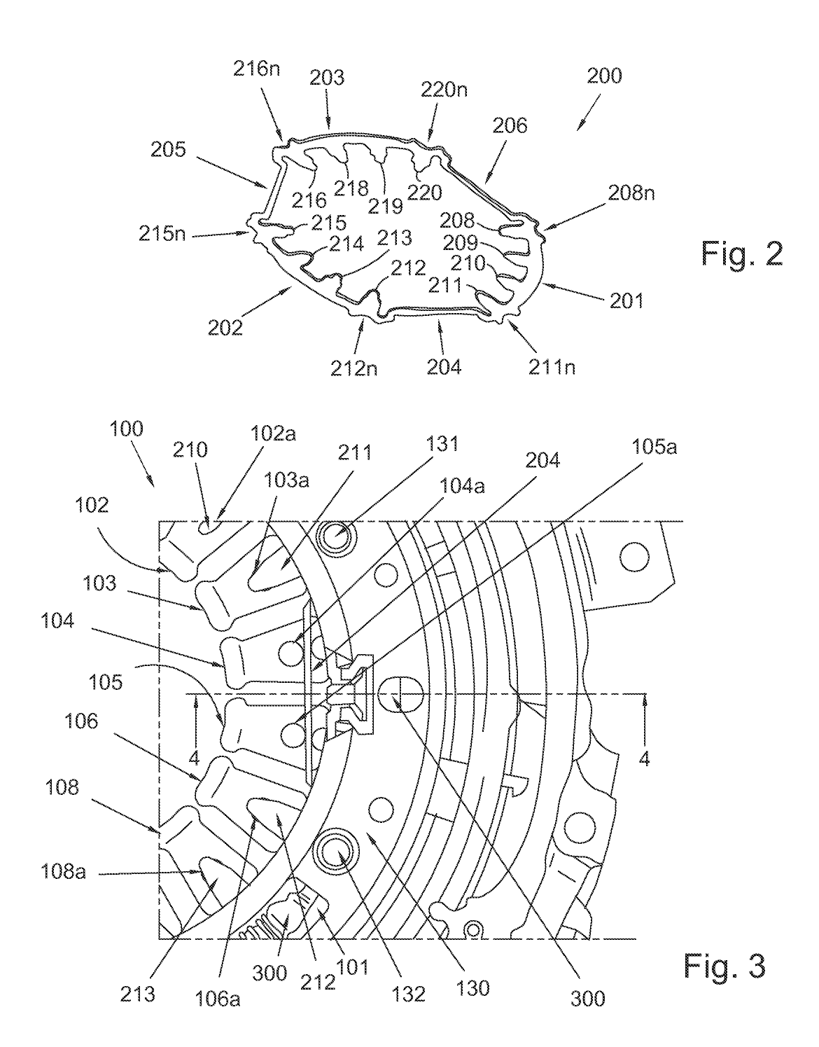

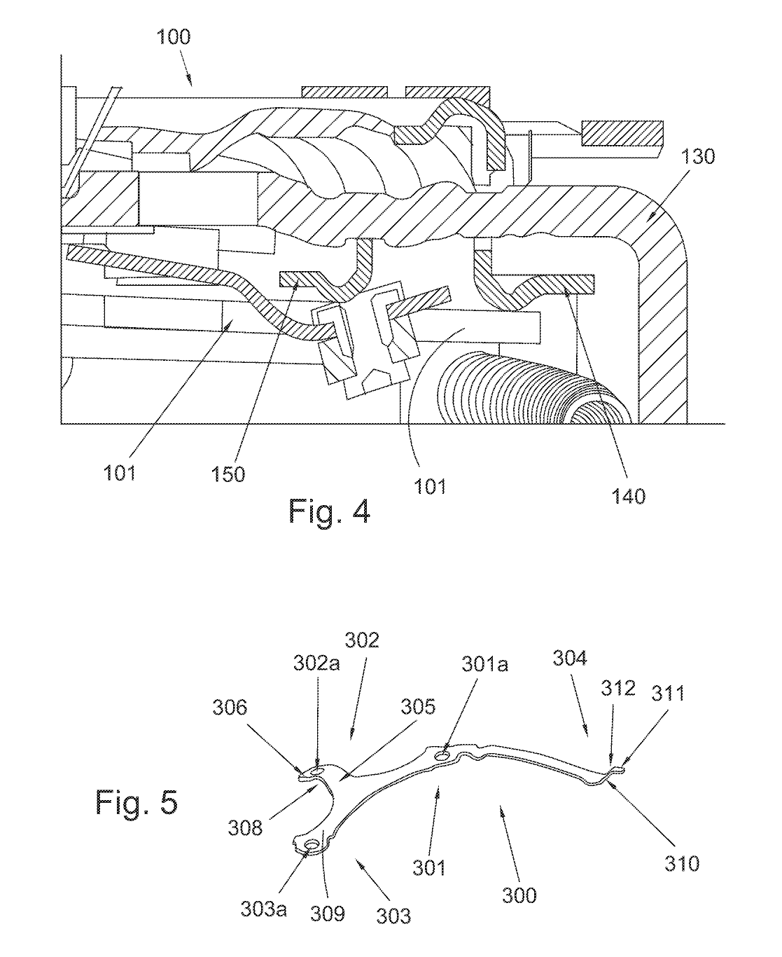

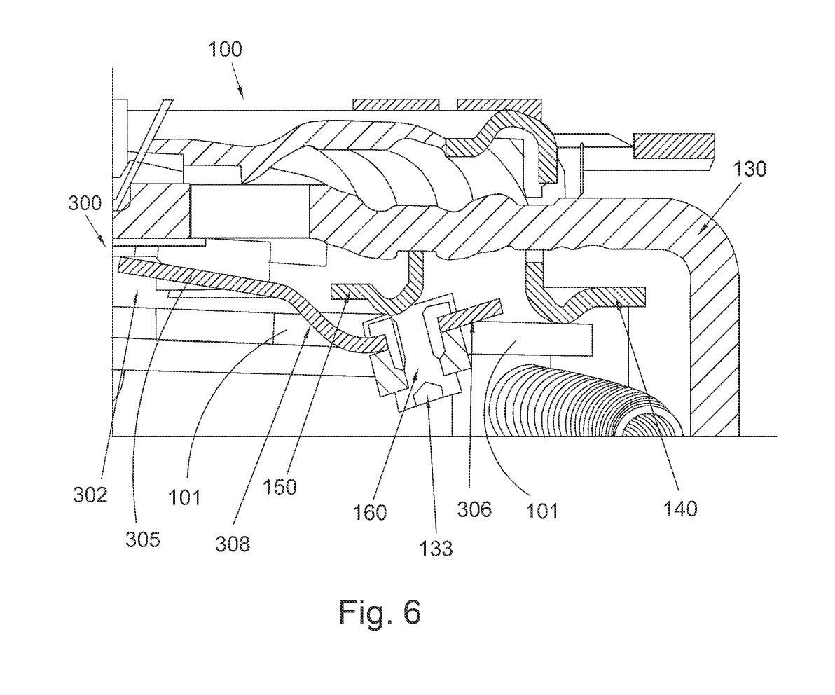

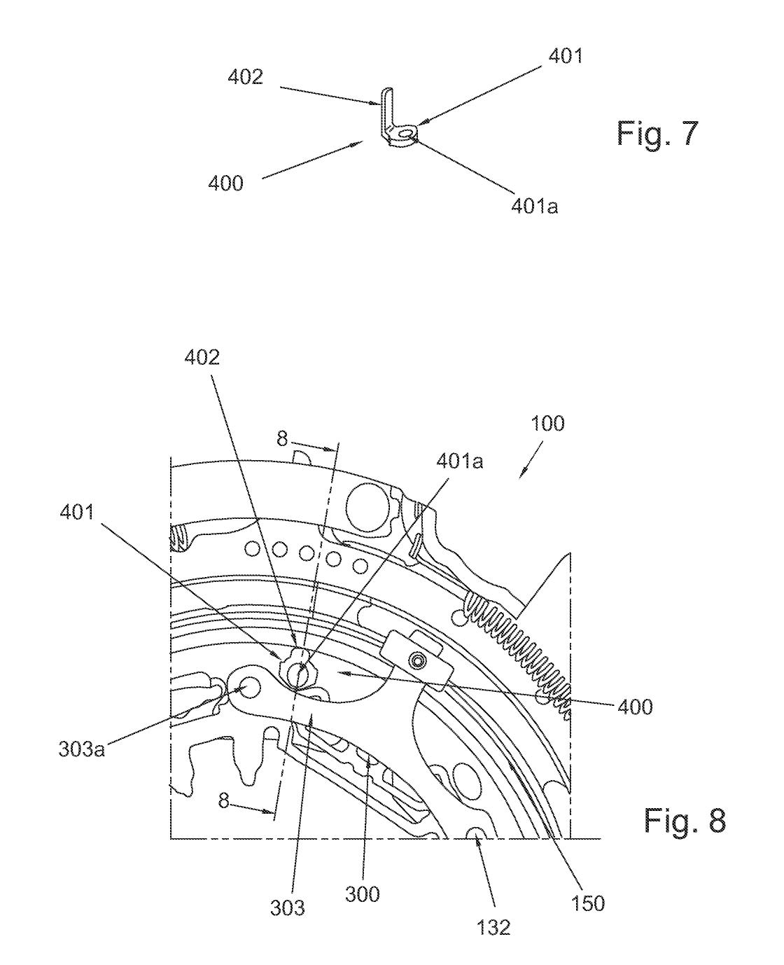

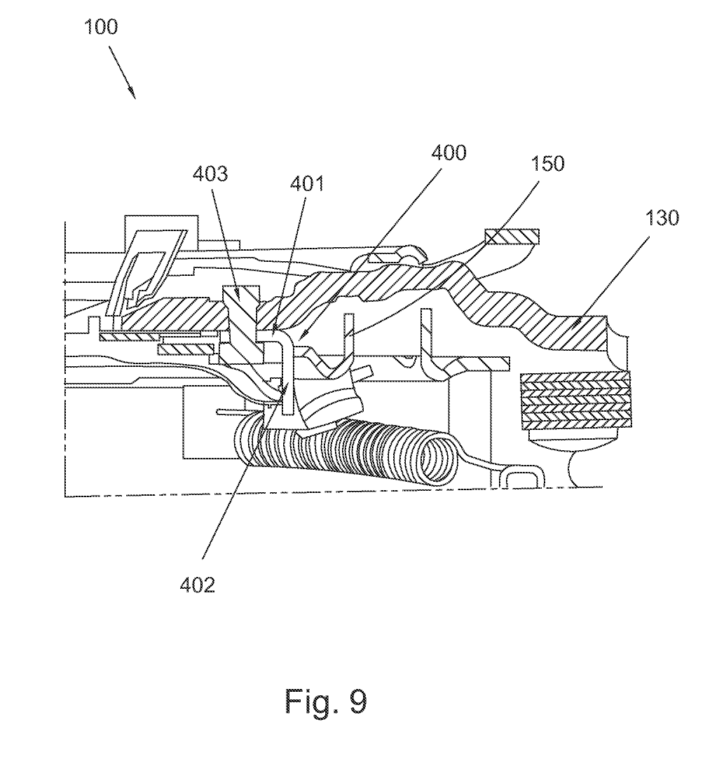

FIG. 1A is a perspective view of cylindrical coordinate system 10 demonstrating spatial terminology used in the present patent. The present invention is at least partially described within the context of cylindrical coordinate system 10. System 10 has a longitudinal axis 1, used as the reference for the directional and spatial terms that follow. Axial direction AD is parallel to axis 1. Radial direction RD is orthogonal to axis 1. Circumferential direction CD is defined by an endpoint of radius R (orthogonal to axis 1) rotated about axis 1.

To clarify the spatial terminology, objects 4, 5, and 6 are used. Surface 7 of object 4 forms an axial plane. For example, axis 1 is congruent with surface 7. Surface 8 of object 5 forms a radial plane. For example, radius 2 is congruent with surface 8. Surface 9 of object 6 forms a circumferential surface. For example, circumference 3 is congruent with surface 9. As a further example, axial movement or disposition is parallel to axis 1; radial movement or disposition is orthogonal to axis 2, and circumferential movement or disposition is parallel to circumference 3. Rotation is described herein with respect to axis 1.

The adverbs “axially,” “radially,” and “circumferentially” are used with respect to an orientation parallel to axis 1, radius 2, or circumference 3, respectively. The adverbs “axially,” “radially,” and “circumferentially” are also used regarding orientation parallel to respective planes.

FIG. 1B is a perspective view of object 15 in cylindrical coordinate system 10 of FIG. 1A demonstrating spatial terminology used in the present patent. Cylindrical object 15 is representative of a cylindrical object in a cylindrical coordinate system and is not intended to limit the claims of the present invention in any manner. Object 15 includes axial surface 11, radial surface 12, and circumferential surface 13. Surface 11 is part of an axial plane; surface 12 is part of a radial plane, and surface 13 is part of a circumferential plane.

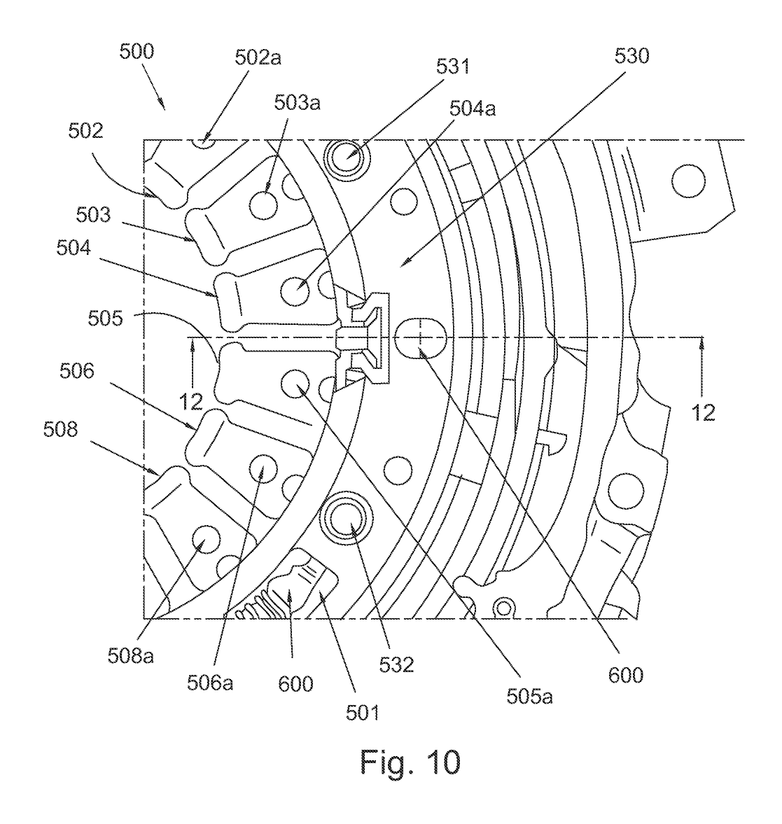

FIG. 10 is a fragmentary top view of the adjustment means of clutch assembly 500 of the present invention having at least one clutch, of which the adjustment means compensates for the wear of at least one friction disc. In order to compensate for the wear of the friction disc, clutch assembly 500 comprises a preloaded adjuster ring 540 (shown in FIG. 12) and a preloaded sensor ring 550 (shown in FIG. 12) with ramps being provided between clutch housing 530 and lever plate 501. The adjuster ring 540 and sensor ring 550 are preloaded in a circumferential direction with pressure springs such that when the friction disc becomes increasingly worn, the adjuster ring 540 (shown in FIG. 12) and sensor ring 550 (shown in FIG. 12) move in order to compensate the gap created between the pressure plate and the friction disc.

The activation of the adjustment process is determined by sensor devices which measure a travel or actuating force of lever arms 502, 503, 504, 505, 506, and 508. Lever arms 502, 503, 504, 505, 506, and 508 further include apertures 502a, 503a, 504a, 505a, 506a and 508a, respectively. The sensor devices comprise clamp spring 600 and adjustment tab 560 (shown in FIG. 12). Clamp spring 600, which is operably engaged with adjustment tab 560 (shown in FIG. 12), is fixedly secured to housing 530 of clutch assembly 500 by rivets 531 and 532.

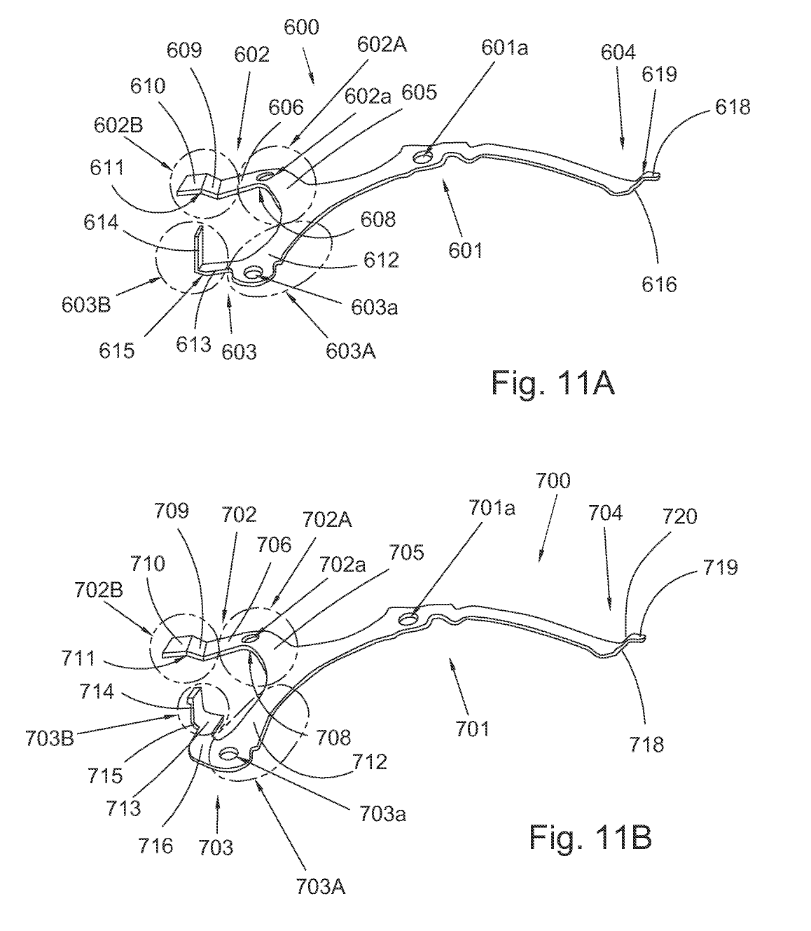

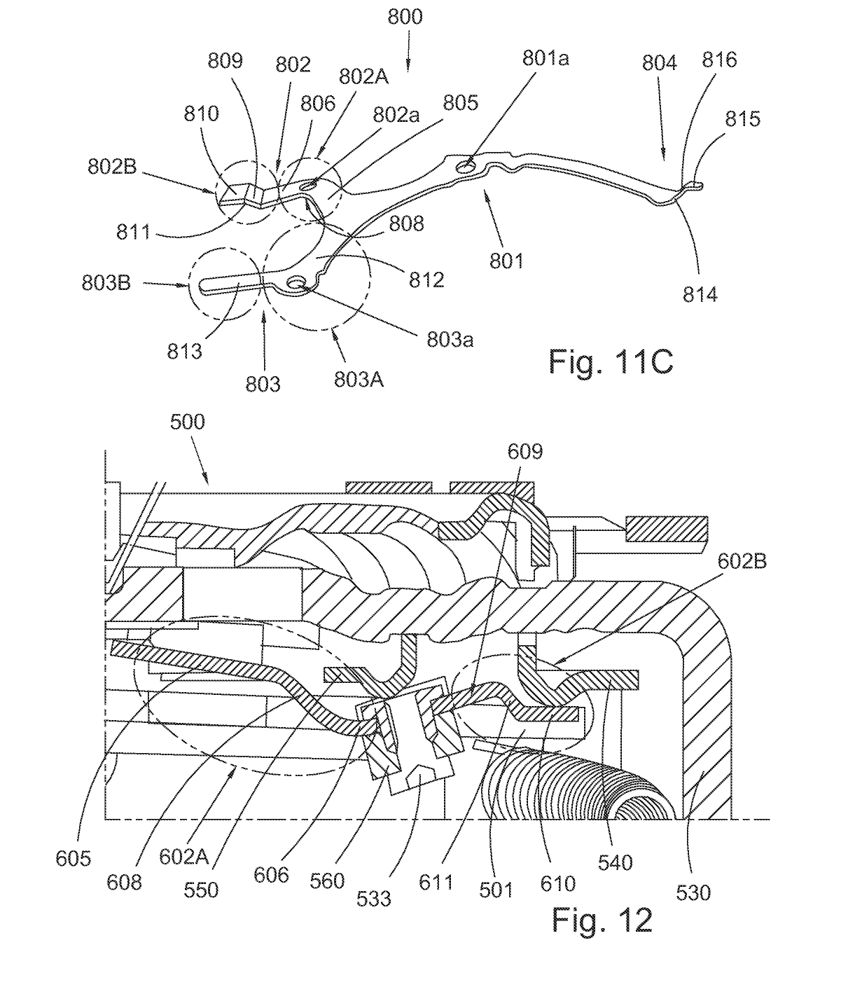

FIGS. 11A-11C are perspective views of various embodiments of clamp spring 600, 700 and 800, respectively, of the present invention. It should be noted that clamp spring 600, 700 and 800 all perform identical functions. FIG. 11A is a perspective view of clamp spring 600 of the present invention, illustrating clamp spring 600 which includes nose 602B and tab 603B. In FIG. 11A, clamp spring 600 is formed as a tripartite member fixedly secured to housing 530 (shown in FIG. 10) of clutch assembly 500 (shown in FIG. 10). Clamp spring 600 includes body 601, first end 602, second end 603 and third end 604. First end 602 of body 601 includes first end 602A and nose 602B. First end 602A is formed by first flat member 605, second flat member 606 and arcuate member 608, whereby the first and second flat members 605 and 606 are fixedly connected by arcuate member 608. Nose 602B is formed by first flat member 609, second flat member 610 and arcuate member 611, whereby the first and second flat members 609 and 610 are fixedly connected by arcuate member 611. First end 602A and nose 602B are fixedly connected and operably arranged to engage with adjuster ring 540 (shown in FIG. 12) of clutch assembly 500 (shown in FIG. 12). It should be appreciated that nose 602B of clamp spring 600 prevents an uncontrolled movement of adjuster ring 540 (shown in FIG. 12) prior to installation of clutch assembly 500 (shown in FIG. 12) within an automobile.

Second end 603 of body 601 includes second end 603A and tab 603B. Second end 603A is formed by flat member 612. Tab 603B is formed by first flat member 613, second flat member 614 and arcuate member 615, whereby the first and second flat members 613 and 614 are fixedly connected by arcuate member 615. Second end 603A and nose 603B are fixedly connected and operably arranged to engage with sensor ring 550 (shown in FIG. 12) of clutch assembly 500 (shown in FIG. 12). It should be appreciated that tab 603B of clamp spring 600 prevents an uncontrolled movement of sensor ring 550 (shown in FIG. 12) after installation of clutch assembly 500 (shown in FIG. 12) within an automobile.

Third end 604 of body 601 is formed by first flat member 616, second flat member 618 and arcuate member 619, whereby the first and second flat members 616 and 618 are fixedly connected by arcuate member 619. Body 601, first end 602A and second end 603A of clamp spring 600 further include apertures 601a, 602a and 603a, respectively.

FIG. 11B is a perspective view of another embodiment of clamp spring 700 of the present invention, illustrating clamp spring 700 which includes nose 702B and tab 703B. In FIG. 11B, clamp spring 700 is formed as a tripartite member fixedly secured to housing 530 (shown in FIG. 12) of clutch assembly 500 (shown in FIG. 12). Clamp spring 700 includes body 701, first end 702, second end 703 and third end 704. First end 702 of body 701 is comprised of first end 702A and nose 702B. First end 702A is formed by first flat member 705, second flat member 706 and arcuate member 708, whereby the first and second flat members 705 and 706 are fixedly connected by arcuate member 708. Nose 702B is formed by first flat member 709, second flat member 710 and arcuate member 711, whereby the first and second flat members 709 and 710 are fixedly connected by arcuate member 711. First end 702A and nose 702B are fixedly connected and operably arranged to engage with adjuster ring 550 (shown in FIG. 12) of clutch assembly 500 (shown in FIG. 12). It should be appreciated that nose 702B of clamp spring 700 prevents an uncontrolled movement of adjuster ring 540 (shown in FIG. 12) prior to installation of clutch assembly 500 (shown in FIG. 12) in an automobile.

Second end 703 of body 701 includes second end 703A and tab 703B. Second end 703A is formed by flat member 712. Tab 703B is formed by first flat member 713, second flat member 714 and arcuate member 715, whereby the first and second flat members 713 and 714 are fixedly connected by arcuate member 715. Second end 703A and tab 703B are fixedly connected by arcuate member 716 and operably arranged to engage with sensor ring 540 (shown in FIG. 12) of clutch assembly 500 (shown in FIG. 12). It should be appreciated that tab 703B of clamp spring 700 prevents an uncontrolled movement of sensor ring 550 (shown in FIG. 12) after installation of clutch assembly 500 (shown in FIG. 12) in an automobile.

Third end 704 of body 701 is formed by first flat member 718, second flat member 719 and arcuate member 720, whereby the first and second flat members 718 and 719 are fixedly connected by arcuate member 720. Body 701, first end 702A and second end 703A of clamp spring 700 further include apertures 701a, 702a and 703a, respectively.

FIG. 11C is a perspective view of a further embodiment of clamp spring 800, illustrating clamp spring 800 which includes 802B and tab 803B. In FIG. 11C, clamp spring 800 is formed as a tripartite member fixedly secured to housing 530 (shown in FIG. 12) of clutch assembly 500 (shown in FIG. 12). Clamp spring 800 includes body 801, first end 802, second end 803 and third end 804. First end 802 of body 801 includes first end 802A and nose 802B. First end 802A is formed by first flat member 805, second flat member 806 and arcuate member 808, whereby the first and second flat members 805 and 806 are fixedly connected by arcuate member 808. Nose 802B is formed by first flat member 809, second flat member 810 and arcuate member 811, whereby the first and second flat members 809 and 810 are fixedly connected by arcuate member 811. First end 802A and nose 802B are fixedly connected and operably arranged to engage adjuster ring 550 (shown in FIG. 12) of clutch assembly 500 (shown in FIG. 12). It should be appreciated that nose 802B of clamp spring 800 prevents an uncontrolled movement of adjuster ring 540 (shown in FIG. 12) prior to installation of clutch assembly 500 (shown in FIG. 12) in an automobile.

Second end 803 of body 801 includes second end 803A and tab 803B. Second end 803A is formed by flat member 812. Tab 803B is formed by flat member 813. Second end 803A and tab 803B are fixedly connected and operably arranged to engage sensor ring 540 (shown in FIG. 12) of clutch assembly 500 (shown in FIG. 12). It should be appreciated that tab 803B of clamp spring 800 prevents an uncontrolled movement of sensor ring 550 (shown in FIG. 12) after installation of clutch assembly 500 (shown in FIG. 12) in an automobile.

Third end 804 of body 801 is formed by first flat member 814, second flat member 815 and arcuate member 816, whereby the first and second flat members 814 and 815 are fixedly connected by arcuate member 816. Body 801, first end 802A and second end 803A of clamp spring 800 further include apertures 801a, 802a and 803a, respectively.

FIG. 12 is a fragmentary cross sectional view of the adjustment means of clutch assembly 500 of the present invention having clamp spring 600 (shown in FIG. 11A) with nose 602B taken along line 12-12 in FIG. 10. In FIG. 12, clamp spring 600 (shown in FIG. 11A) which includes nose 602B (shown in FIG. 11A) prevents an uncontrolled movement of the adjustment means of clutch assembly 500 when in an uninstalled state by operatively applying a load to adjuster ring 540 and thereby preventing an axial movement of adjuster ring 540. The nose 602B of clamp spring 600 (shown in FIG. 11A) includes first flat member 809, second flat member 610 and arcuate member 611, and the first and second flat members 809 and 810 are fixedly connected by arcuate member 611. Second flat member 610 of nose 602B of clamp spring 600 (shown in FIG. 11A) engages with adjuster ring 540 of clutch assembly 500. Clamp spring 600 (shown in FIG. 11A) is positioned between lever plate 501 and housing 530 of clutch assembly 500. Clamp spring 600 (shown in FIG. 11A) is fixedly secured to housing 530 of clutch assembly 500 by rivets 531 and 532 (shown in FIG. 10). It should be appreciated that nose 602B of clamp spring 600 (shown in FIG. 10) prevents an uncontrolled movement of adjuster ring 540 prior to installation of clutch assembly 500 in an automobile.

The Adjustment tab 560 is fixedly secured to second flat member 606 of first end 602A of first end 602 (shown in FIG. 11A) of body 601 (shown in FIG. 11A) of clamp spring 600 (shown in FIG. 11A) by bolt 533, which passes from adjustment tab 560 through aperture 602a (shown in FIG. 11A) of second flat member 606 of first end 602A. The first end 602A further includes first flat member 605, second flat member 606 and arcuate member 608, whereby the first and second flat members 605 and 606 are fixedly secured by arcuate member 608. The adjustment tab 560, which is fixedly secured to clamp spring 600 (shown in FIG. 11A), is also engaged with lever plate 501. Clamp spring 600 (shown in FIG. 11A) and adjustment tab 560 measure the travel of lever arms 502, 503, 504, 505, 506, and 508 (shown in FIG. 10).

Throughout the lifetime of clutch assembly 500, the distance between the pressure plate and the friction disc should remain constant. However, as the clutch disc becomes increasingly worn, the distance between the pressure plate and the friction disc increases which in turn results in an increase in the load or actuating force placed on lever arms 502, 503, 504, 505, 506 and 508 (shown in FIG. 10) necessary to engage the pressure plate with the friction disc. The adjustment tab 560, which is fixedly secured to clamp spring 600 (shown in FIG. 11A) and places a predefined load on sensor ring 550, senses the amount of wear or distance between the pressure plate and the friction disc. The adjustment tab 560 is further placed over lever plate 501, whereby an increase in the travel necessary to engage the pressure plate with the friction disc (larger than the gap between adjustment tab 560 and lever plate 501) produces a higher axial movement of lever plate 501, engaging adjustment tab 560. Since adjustment tab 560 is also fixedly secured to clamp spring 600 (shown in FIG. 11A), the axial movement of lever plate 501 causes adjustment tab 560 and clamp spring 600 (shown in FIG. 11A) to undergo a travel or distance equal to the increase in distance between the pressure plate and the worn friction disc.

To compensate for the increased travel or distance between adjustment tab 560 and sensor ring 550, and thus an increase in the distance necessary for the pressure plate to engage with the friction disc, sensor ring 550 moves axially to reengage with adjustment tab 560. As sensor ring 550 reengages with adjustment tab 560, adjuster ring 540 simultaneously moves axially a distance equal to the distance traveled by sensor ring 550. As adjuster ring 550 moves axially, adjustment means (comprising adjuster ring 540, sensor ring 550, clamp spring 600 (shown in FIG. 11A), adjustment tab 560 and lever plate 501) is moved axially a distance equivalent to that traveled by adjuster ring 540 and sensor ring 550, such that the distance between the pressure plate and the friction disc remains constant.

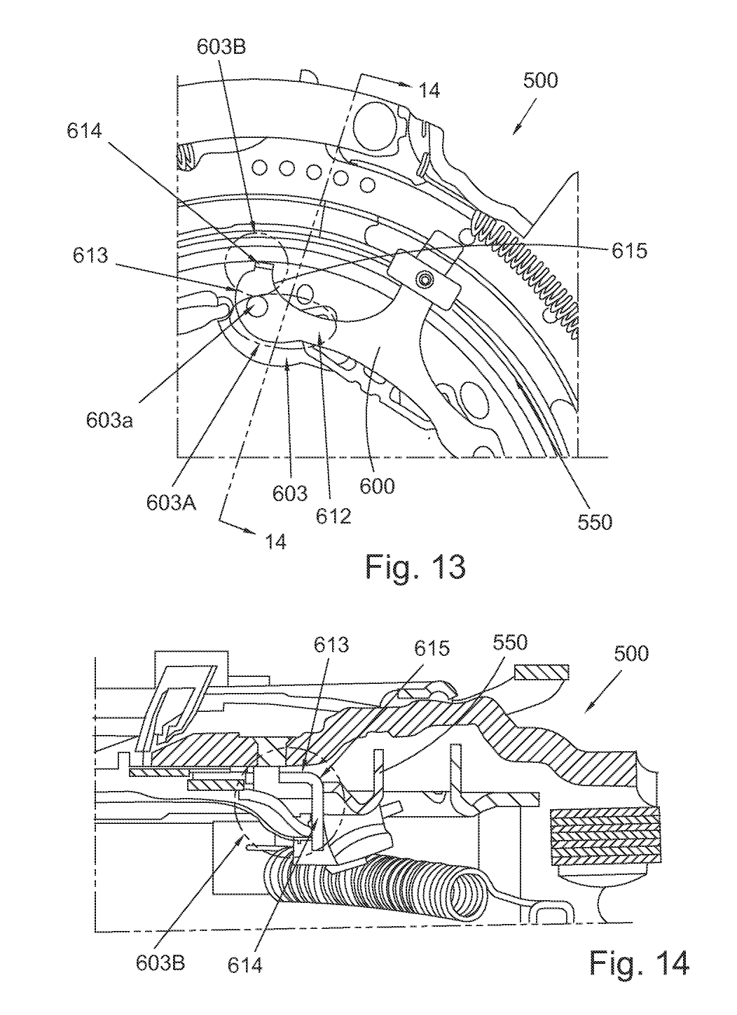

FIGS. 13-18 show clutch assembly 500 with various embodiments of a clamp spring 600, 700 and 800 having tab 603B, 703B and 803B, (shown in FIGS. 11A, 11B and 11C) respectively. FIG. 13 is a fragmentary top view of the adjustment means of clutch assembly 500 of the present invention, illustrating clamp spring 600 which includes tab 603B. It should be appreciated that clamp spring 600 and tab 603B are a single, unified structure. In FIG. 13, tab 603B further prevents an uncontrolled movement of sensor ring 550. With housing 530 removed, aperture 603a of clamp spring 600 can be seen. Second end 603A of second end 603 of clamp spring 600 is fixedly secured to housing 530 (shown in FIG. 10) by rivet 531 (shown in FIG. 10), which passes through aperture 603a. Flat member 612 of second end 603A and first flat member 613 of tab 603B lie perpendicular to the plane of axis of second flat member 614 of tab 603B. As clutch assembly 500 rotates about an axis of rotation, second flat member 614 of clamp spring 600 engages sensor ring 550 to center the sensor ring and prevent an uncontrolled movement within a plane perpendicular to the axis of rotation of clutch assembly 500.

FIG. 14 is a fragmentary partial cross section of the adjustment means of clutch assembly 500 of the present invention, illustrating clamp spring 600 (shown in FIG. 13) which includes tab 603B taken generally along line 14-14 in FIG. 13. It should be appreciated that clamp spring 600 (shown in FIG. 13) and tab 603B form a single, unified structure. In FIG. 14, tab 603B of clamp spring 600 (shown in FIG. 13) engages with sensor ring 550 of clutch assembly 500. Tab 603B engages sensor ring 550 of clutch assembly 500 to center sensor ring 550 as sensor ring 150 moves within the axis of rotation clutch assembly 500. Tab 603B is formed by first flat member 613, second flat member 614 and arcuate member 615, whereby the first and second flat members 613 and 614 are fixedly connected by arcuate member 615. Second end 603A (shown in FIG. 11A), comprising first flat member 612 (shown in FIG. 11A) and tab 603B are fixedly connected and operably arranged to engage with sensor ring 550 of clutch assembly 500. Flat member 612 (shown in FIG. 11A) of second end 603A (shown in FIG. 11A) and first flat member 613 of tab 603B lie perpendicular to the plane of axis of second flat member 614 of tab 603B.

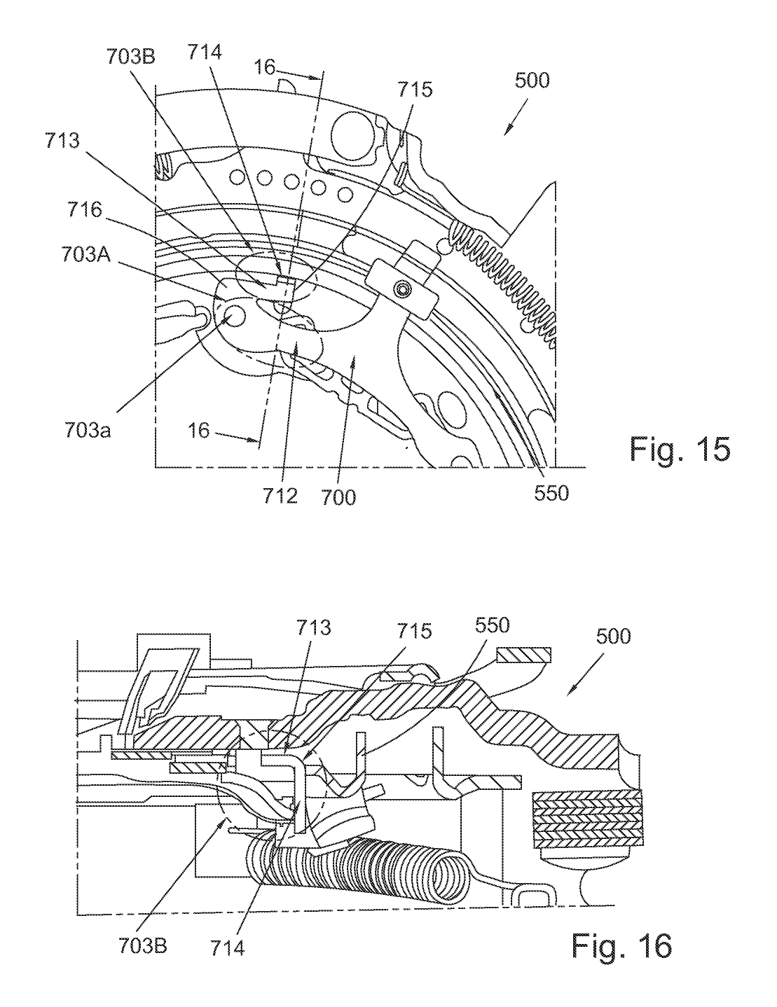

FIG. 15 is a fragmentary top view of the adjustment means of clutch assembly 500 of the present invention, illustrating clamp spring 700 which includes tab 703B. It should be appreciated that clamp spring 700 and tab 703B are a single, unified structure. Tab 703B further prevents an uncontrolled movement of sensor ring 550. With housing 530 removed, aperture 703a of clamp spring 700 can be seen. Second end 703A of second end 703 of clamp spring 700 is fixedly secured to housing 530 (shown in FIG. 10) by rivet 531 (shown in FIG. 10), which passes through aperture 703a. Flat member 712 of second end 703A and first flat member 713 of tab 703B lie perpendicular to the plane of axis of second flat member 714 of tab 703B. As clutch assembly 500 rotates about an axis of rotation, second flat member 714 of clamp spring 700 engages sensor ring 550 to center the sensor ring and prevent it from moving within a plane perpendicular to the axis of rotation of clutch assembly 500.

FIG. 16 is a fragmentary partial cross section of the adjustment means of clutch assembly 500 of the present invention, illustrating clamp spring 700 (shown in FIG. 15) which includes tab 703B taken generally along line 16-16 in FIG. 15. It should be appreciated that clamp spring 700 (shown in FIG. 15) and tab 703B are a single, unified structure. In FIG. 16, tab 703B of clamp spring 700 (shown in FIG. 15) is engaged with sensor ring 550 of clutch assembly 500. Tab 703B engages with sensor ring 550 of clutch assembly 500 to center sensor ring 550 as sensor ring 550 moves within the axis of rotation of clutch assembly 500. Tab 703B is formed by first flat member 713, second flat member 714 and first arcuate member 715, whereby the first and second flat members 713 and 714 are fixedly connected by arcuate member 715. Second end 703A, comprising flat member 712 and tab 703B are fixedly connected by arcuate member 716 and operably arranged to engage with sensor ring 550 of clutch assembly 500. Flat member 712 of second end 703A and first flat member 713 of tab 703B lie perpendicular to the plane of axis of second flat member 714 of tab 703B.

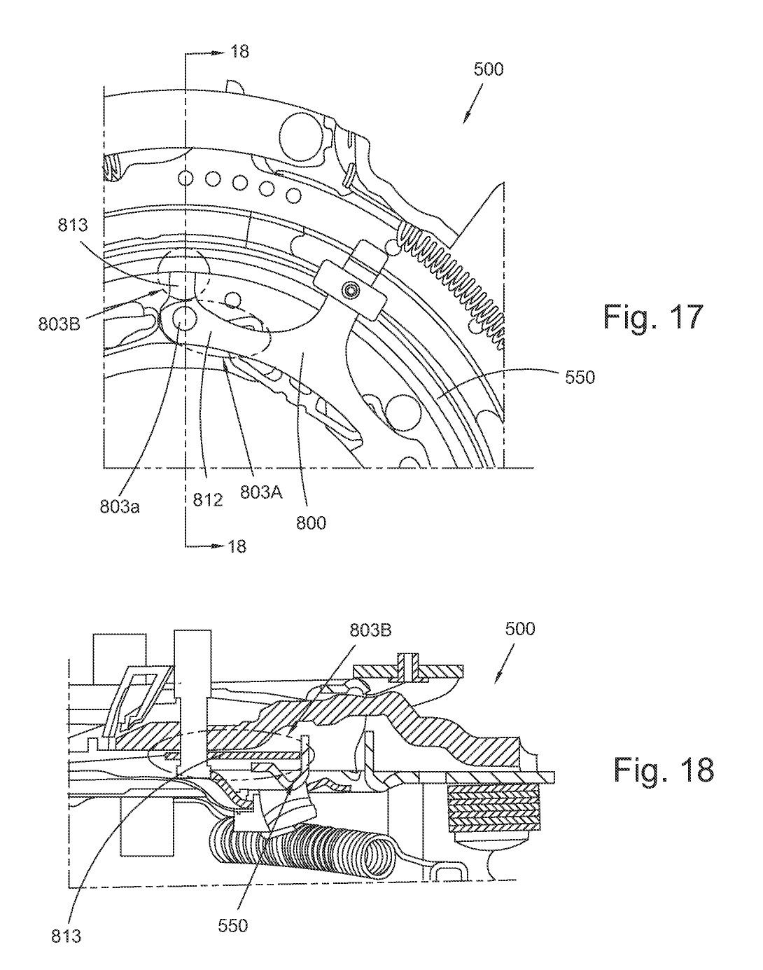

FIG. 17 is a fragmentary top view of the adjustment means of clutch assembly 500 of the present invention, illustrating clamp spring 800 which includes tab 803B. It should be appreciated that clamp spring 800 and tab 803B are a single, unified structure. Tab 803B further prevents an uncontrolled movement of sensor ring 550. Tab 803B engages with sensor ring 550 of clutch assembly 500 to center sensor ring 550 as sensor ring 550 moves within the axis of rotation of clutch assembly 500. Tab 803B is formed by flat member 813. Second end 803A, comprising flat member 812, and tab 803B are fixedly connected and operably arranged to engage with sensor ring 550 of clutch assembly 500.

FIG. 18 is a fragmentary partial cross section of the adjustment means of clutch assembly 500 of the present invention, illustrating clamp spring 800 (shown in FIG. 17) which includes tab 803B taken generally along line 18-18 in FIG. 17. It should be appreciated that clamp spring 800 (shown in FIG. 17) and tab 803B are a single, unified structure. In FIG. 18, tab 803B of clamp spring 800 is engaged with sensor ring 550 of clutch assembly 500. Tab 803B engages with sensor ring 550 of clutch assembly 500 to center sensor ring 550 as sensor ring 150 moves within the axis of rotation of clutch assembly 500. Tab 803B is formed by flat member 813. Second end 803A, comprising flat member 812 and tab 803B are fixedly connected and operably arranged to engage with sensor ring 550 of clutch assembly 500. Flat member 811 of second end 803A and first flat member 812 of tab 803B lie perpendicular to the plane of axis of second flat member 813 of tab 803B.

### LIST OF REFERENCE NUMBERS

1 longitudinal axis
2 radius
3 circumference
4 object
5 object
6 object
7 surface
8 surface
9 surface
10 system
11 surface
12 surface
13 surface
15 object
100 clutch assembly
101 lever plate
102 lever arm
102a aperture
103 lever arm
103a aperture
104 lever arm
104a aperture
105 lever arm
105a aperture
106 lever arm
106a aperture
108 lever arm
108a aperture
130 housing
131 rivet
132 rivet
133 bolt
140 adjuster ring
150 sensor ring
160 adjustment tab
200 transport lock
201 first set of teeth
202 second set of teeth
203 third set of teeth
204 bar
205 bar
206 bar
208 tooth
208n notch
209 tooth
210 tooth
211 tooth
211n notch
212 tooth
212n notch
213 tooth
214 tooth
215 tooth
215n notch
216 tooth
216n notch
218 tooth
219 tooth
220 tooth
220n notch
221 washer
222 washer
300 clamp spring
301 body
301a aperture
302 first end
302a aperture
303 second end
303a aperture
304 third end
305 first flat member
306 second flat member
308 arcuate member
309 flat member
310 first flat member
311 second flat member
312 arcuate member
400 centering pin
401 first flat member
401a aperture
402 second flat member
403 rivet
500 clutch assembly
501 lever plate
502 lever arm
503 lever arm
504 lever arm
505 lever arm
506 lever arm
508 lever arm
530 housing
531 rivet
532 rivet
533 bolt
540 adjuster ring
550 sensor ring
560 adjustment tab
600 damp spring
601 body
602 first end
602A first end
602B nose
603 second end
603A second end
603B tab
603B tab
604 third end
605 first flat member
606 second flat member
608 arcuate member
609 first flat member
610 second flat member
611 arcuate member
612 flat member
613 first flat member
614 second flat member
615 arcuate member
616 first flat member
618 second flat member
619 arcuate member
700 clamp spring
701 body
701a aperture
702 first end
702a aperture
702A first end
702B nose
703 second end
703a aperture
703A second end
703B tab
704 third end
705 first flat member
706 second flat member
708 arcuate member
709 first flat member
710 second flat member
711 arcuate member
712 flat member
713 first flat member
714 second flat member
715 arcuate member
716 arcuate member
718 first flat member
719 second flat member
720 arcuate member
800 clamp spring
801 body
801a aperture
802 first end
802a aperture
802A first end
802B nose
803 second end
803a aperture
803A second end
803B tab
804 third end
805 first flat member
806 second flat member
808 arcuate member
809 first flat member
810 second flat member
811 arcuate member
812 flat member
813 flat member
814 first flat member
815 second flat member
816 arcuate member

What we claim is:

1. A clutch assembly for transferring a torque between a flywheel of an engine and a transmission in a motor vehicle, said clutch assembly comprising a housing, a pressure plate fixedly secured to said housing, said pressure plate operatively arranged to cause a friction clutch disc to rotate said flywheel, wherein said pressure plate is arranged for rotation about an axis of rotation, wherein said pressure plate is axially movable relative to said axis of rotation, and including actuation means for engaging and disengaging said clutch, an adjustment means operatively arranged to adjust travel of said pressure plate and said friction clutch disc, and a plurality of lever arms, operatively arranged to amplify force within said clutch assembly, said adjustment means comprising a clamp spring having a first end operatively arranged to prevent an uncontrolled movement of the adjustment means and a second end operatively arranged to center the adjustment means within the clutch assembly.

2. The clutch assembly as recited in claim 1, wherein said first end comprises a nose operatively arranged to engage said adjustment means.

3. The clutch assembly as recited in claim 2, wherein said nose applies a load to an adjuster ring of said adjustment means.

4. The clutch assembly as recited in claim 2, wherein said nose comprises a first flat member, a second flat member and an arcuate member, said first and second flat members fixedly connected by said arcuate member.

5. The clutch assembly as recited in claim 1, wherein said second end comprises a tab operatively arranged to engage said adjustment means.

6. The clutch assembly as recited in claim 5, wherein said tab is operatively engaged with a sensor ring of said adjustment means.

7. The clutch assembly as recited in claim 5, wherein said tab comprises a first flat member, a second flat member and an arcuate member, said first and second flat members fixedly connected by arcuate member.

8. A clamp spring for a clutch assembly, comprising:
a first end operatively arranged to prevent an uncontrolled movement of an adjustment means and a second end operatively arranged to center an adjustment means within a clutch assembly.

9. The clamp spring as recited in claim 8, wherein said first end comprises a nose operatively arranged to engage said adjustment means.

10. The clamp spring as recited in claim 9, wherein said nose applies a load to an adjuster ring of said adjustment means.

11. The clamp spring as recited in claim 9, wherein said nose comprises a first flat member, a second flat member and an arcuate member, said first and second flat member fixedly connected by arcuate member.

12. The clamp spring as recited in claim 8, wherein said second end comprises a tab operatively arranged to engage said adjustment means.

13. The clamp spring as recited in claim 12, wherein said tab is operatively engaged with a sensor ring of said adjustment means.

14. The clutch assembly as recited in claim 12, wherein said tab comprises a first flat member, a second flat member and an arcuate member, said first and second flat members fixedly connected by arcuate member.

15. A clamp spring for a clutch assembly, comprising:
a first end operatively arranged to prevent an uncontrolled movement of an adjustment means and a second end operatively arranged to center an adjustment means within a clutch assembly.

16. The clamp spring as recited in claim 15, wherein said first end comprises a nose operatively arranged to engage said adjustment means.

17. The clamp spring as recited in claim 16, wherein said nose applies a load to an adjuster ring of said adjustment means.

18. The clamp spring as recited in claim 16, wherein said nose comprises a first flat member, a second flat member and an arcuate member, said first and second flat member fixedly connected by arcuate member.

19. The clamp spring as recited in claim 15, wherein said second end comprises a tab operatively arranged to engage said adjustment means.

20. The clamp spring as recited in claim 19, wherein said tab is operatively engaged with a sensor ring of said adjustment means.

21. The clamp spring as recited in claim 19, wherein said tab comprises a first flat member, a second flat member, a first arcuate member and a second arcuate member, said first and second flat members fixedly connected by first arcuate member, said first flat member fixedly connected to said second arcuate member.

22. A clamp spring for a clutch assembly, comprising:
a first end operatively arranged to prevent an uncontrolled movement of an adjustment means and a second end operatively arranged to center an adjustment means within a clutch assembly.

23. The clamp spring as recited in claim 22, wherein said first end comprises a nose operatively arranged to engage said adjustment means.

24. The clamp spring as recited in claim 23, wherein said nose applies a load to an adjuster ring of said adjustment means.

25. The clamp spring as recited in claim 23, wherein said nose comprises a first flat member, a second flat member and an arcuate member, said first and second flat member fixedly connected by arcuate member.

26. The clamp spring as recited in claim 22, wherein said second end comprises a tab operatively arranged to engage said adjustment means.

27. The spring as recited in claim 24, wherein said tab is operatively engaged with a sensor ring of said adjustment means.

28. The clamp spring as recited in claim 12, wherein said tab comprises a flat member
